(19) United States
(12) Patent Application Publication
(10) Pub. No.: US 2006/0208408 A1
(43) Pub. Date: Sep. 21, 2006

(54) Underbody clamping device for work pieces, having a hook-shaped clamping member

(75) Inventor: Luciano Migliori, Milano (IT)

Correspondence Address: YOUNG & THOMPSON, 745 SOUTH 23RD STREET, 2ND FLOOR, ARLINGTON, VA, 22202, US

(73) Assignee: UNIVER S.P.A., MILANO (IT)

(21) Appl. No.: 11/377,285

(22) Filed: Mar. 17, 2006

(30) Foreign Application Priority Data
Mar. 17, 2005 (IT) MI2005U000087

(51) Int. Cl. B23Q 3/08

(52) U.S. Cl. 269/32

(57) ABSTRACT

The underbody clamping device for work pieces includes a box-shaped body for supporting a movable clamping member having a fore hook-shaped portion which extends outwardly from the box-shaped body, and a rear shank. The device also includes a drive member tiltably supported by the box-shaped body, operatively connected to the shank of the clamping member by a hinge axis; the device further includes guide elements for guiding the clamping member, which include first and second arch shaped slots in the rear shank, and first and second guide pins secured to the box-shaped body which extend respectively into the first and into the second arch shaped slots, the arch shaped slots being conformed and arranged to cause the clamping member to move parallel to the longitudinal axis of the body, along an arched path corresponding to a rotational path of the hinge axis of the tiltable drive member.

### BACKGROUND OF THE INVENTION

The present invention concerns an underbody clamping device for work pieces, having a hook-shaped clamping member, used in particular for underbody gripping metal sheets along a motor vehicle body assembly line.

### STATE OF THE ART

In general, in the automotive field, use is made of underbody clamping devices for work pieces, having a hook-shaped clamping member, whereby it is possible for example to grip metal sheets, through appropriate holes or along edges of the same metal sheets, in such a way as to be able to join or weld them together to construct the bodywork of a motor vehicle.

A clamping device of this type, for example known from EP-A-1 123 779 and EP-A-1 391 266, in general comprises a box-shaped body for supporting a movable clamping member between a forward releasing position and a backward retaining position for respectively releasing and retaining a work piece; the clamping member has a fore hook-shaped portion which outwardly extends from a fore end of the box-shaped body, through a suitable opening, and a rear shank provided with a shaped slot along which a guide pin slides for guiding the movement of the clamping member, the guide pin being fixedly connected to the box-shaped body of the device.

The device also comprises a linear actuator having a movable rod connected to the shank of the clamping member by a hinge pin, so as to allow the clamping member to perform a longitudinal movement with respect to the box-shaped body, and at the same time a tilting movement of the same clamping member with respect to the rod of the actuator, the overall movement of the clamping member being guided by the guide pin sliding within the shaped slot in the shank of the same clamping member.

A device of this kind however has several functional drawbacks; in particular, the direct connection between the rod of the actuator and the clamping member does not allow high clamping forces to be exerted, unless use is made of a high power linear actuator, resulting in considerable costs and overall dimensions.

Moreover, a clamping device of this kind does not guarantee an irreversible clamping of the work pieces in the event of operative failing of the linear actuator, for example due to a breakdown or malfunctioning, or in the event of external forces being exerted on the work pieces, with consequent problems related to the operative safety of the device.

A further drawback concerns the guide means for the movement of the clamping member, in particular the shaped slot in the shank of the clamping member and the guide pin secured to the box-shaped body, in that the sliding of the guide pin along the shaped slot generates frictional forces which limit the precision in controlling the movement of the clamping member and, with a prolonged use in the time, it give rise to deterioration of the same guide means.

### OBJECTS OF THE INVENTION

The main object of this invention is to provide an underbody clamping device for work pieces, having a hook-shaped clamping member, which is structurally simple and allows high clamping forces to be exerted while using actuators of limited power, and which guarantees an irreversible clamping of the work pieces in the event of operative failing of the linear actuator or in the event of the action of external forces which tend to unclamp the work pieces.

A further object of this invention is to provide an underbody clamping device for work pieces, of the aforementioned kind, which offers a more precise control of the movement of the clamping member, limiting the frictional forces between the guide means for the clamping member, and at the same time reducing the wear phenomena related to the latter.

### BRIEF DESCRIPTION OF THE INVENTION

The above can be achieved by means of an underbody clamping device for work pieces, of the type comprising:

a box-shaped body having a longitudinal axis;

a clamping member, movable between a forward releasing position and a backward retaining position for a work piece, said clamping member comprising a hook-shaped portion at a fore end which extends outwardly through a fore opening of the box-shaped body, and a rear shank;

drive means operatively connected to the clamping member and to a linear actuator, the drive means comprising a drive member, tiltably supported by a pivotal axis connected to the box-shaped body, said tiltable drive member being operatively connected to the shank of the clamping member by a hinge axis, and

guide means for the clamping member, comprising first and second arch shaped slots in said rear shank, and first and second guide pins secured to the box-shaped body, respectively extending into the first and second arch shaped slots, said first and second arch shaped slots being conformed and arranged to cause the clamping member to parallely move with respect to the longitudinal axis of the box-shaped body, along an arched path corresponding to a rotational path of the hinge axis between the tiltable drive member and the rear shank of the clamping member of the device.

### BRIEF DESCRIPTION OF THE DRAWINGS

These and further features according to this invention, will be more clearly evident from the following description with reference to the accompanying drawings, in which:

FIG. 1 shows a cross-sectional front view of an underbody clamping device for work pieces according to this invention, with the clamping member in the backward position for retaining a work piece;

FIG. 2 shows a cross-sectional front view of the clamping device of FIG. 1, with the clamping member in the forward position for releasing the work pieces.

### DETAILED DESCRIPTION OF THE INVENTION

The general features of this invention will be illustrated hereunder by means of an exemplificative embodiment.

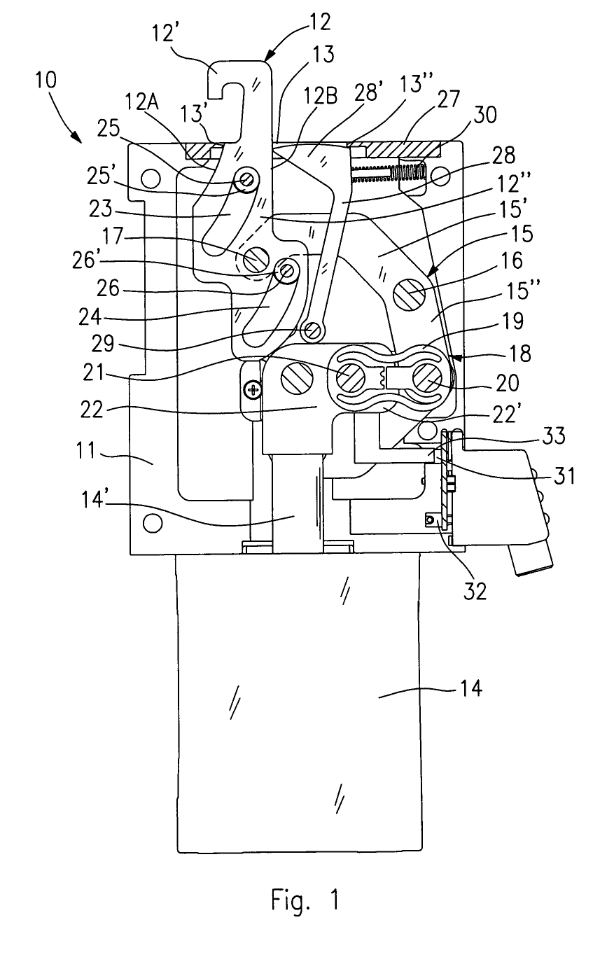

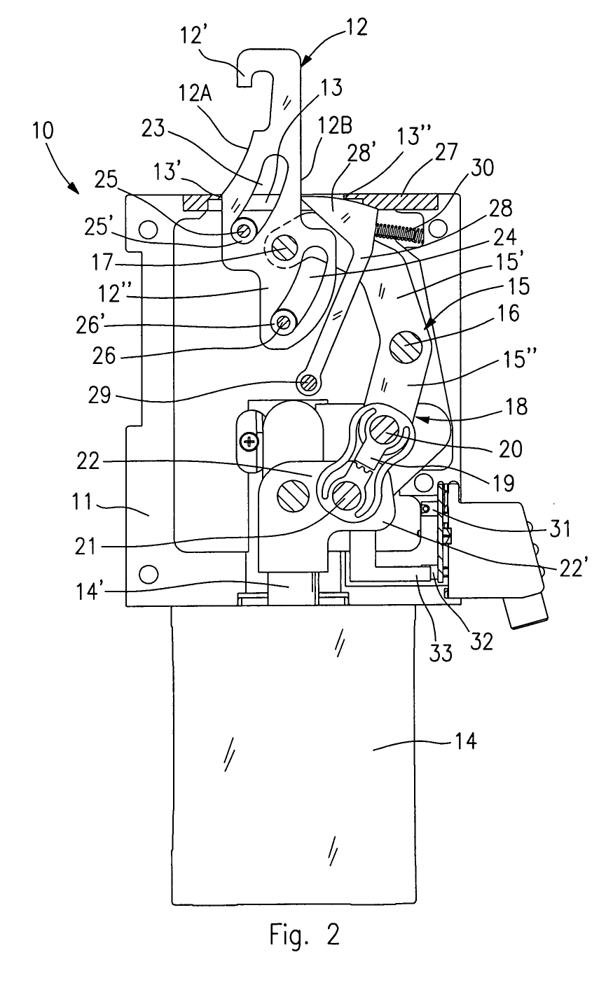

FIGS. 1 and 2 show an underbody clamping device for work pieces according to this invention, indicated as a whole by the reference number 10; in particular, the device 10 comprises a box-shaped body 11 having a longitudinal axis, which supports a clamping member 12, movable between a forward releasing position and a backward retaining position for respectively releasing and retaining a work piece.

The clamping member 12 in turn comprises a hook-shaped portion 12′ at a fore end, which extends outwardly through a fore opening 13 in the box-shaped body 11, and a rear shank 12″; the clamping member 12 also has a front longitudinal surface 12A, on a side of the clamping member 12, and a back longitudinal surface 12B on the opposite side of the clamping member 12.

The clamping member 12 is operatively connected to a longitudinally movable rod 14′ of a linear actuator 14, for example a pneumatic cylinder or an electric-type actuator, by drive means comprising a drive member 15 tiltably supported by a pivotal axis 16 connected to the box-shaped body 11, next to a side of the same body; preferentially, the drive member 15 is in the form of an incurved tiltable lever, pivotally connected to the box-shaped body 11 at an intermediate point 16 of the same lever 15, which comprises a first lever arm 15′ extending in a first direction, operatively connected to the shank 12″ of the clamping member 12 by a hinge axis 17, and a second lever arm 15″ which extends in a second direction, on an opposite side with respect to the pivotal axis 16.

The drive member 15 is operatively connected to the movable rod 14′ of the actuator 14 by a toggle-lever mechanism 18, comprising the second lever arm 15″ of the same drive member 15 and an intermediate connecting link 19, the latter being hingedly connected to the second arm 15″ by a hinge axis 20, as well as connected by a hinge axis 21 to a side end portion 22′ of a fork shaped element 22 secured to the movable rod 14′ of the actuator 14.

Preferentially, the connecting link 19 is elastically yieldable in an axial direction in a controlled manner.

The clamping device 10 according to this invention, comprising a toggle-lever mechanism 18 provided with an elastically yieldable connecting link 19 in an axial direction in a controlled manner, allows to achieve an irreversible condition of the movement of the clamping member 12 in correspondence with the retaining position for the work pieces, in such a way as to prevent an accidental release of the work pieces, for example in the event of malfunctioning of the linear actuator or in the presence of external forces tending to move forward the clamping member 12.

Moreover, due to the fact that the clamping member 12 is connected to the linear actuator 14 by means of the drive member 15 and the toggle-lever mechanism 18, the clamping device 10 according to the invention allows to multiply the clamping force exerted by the clamping member 12, starting from a same linear actuator 14, or, alternatively, to make use of a linear actuator 14 of lower power and smaller overall dimensions, while maintaining the clamping force of the clamping member 12 unchanged.

The clamping device 10 also comprises guide means for slidingly guiding the clamping member 12, in turn comprising a first and a second arch shaped slot 23, 24 in the rear shank 12″ of the clamping member 12, and a first and a second guide pin 25, 26 secured to the box-shaped body 11, which extend respectively into the first 23 and into the second 24 arch shaped slot.

Said arch shaped slots 23, 24 are conformed and arranged in such a way as to cause the clamping member 12 to parallely move with respect to the longitudinal axis of the box-shaped body 11, along an arched path corresponding to a rotational path of the hinge axis 17 between the tiltable drive member 15 and rear shank 12″ of the clamping member 12.

In this way the clamping member 12 is precisely guided between the releasing position and the retaining position for the work pieces, without undesired tilting movements, limiting at the same time the resistances and frictional forces due to the sliding, compared to a known single guide slot and pin, since it is possible to distribute stresses over two guide slots 23, 24.

Preferentially, the arch shaped slots 23, 24 are parallely arranged to each other in the rear shank 12″ of the clamping member 12, and have respective curvature centres disposed on an opposite side of the clamping member 12 with respect to the pivotal axis 16 of the tiltable drive member 15.

Moreover, preferentially the hinge axis 17 of the drive member 15 is connected to the clamping member 12 in an intermediate position between the first 23 and the second 24 arch shaped slots.

In order to reduce the frictional forces and the wear deriving from the sliding of the guide pins 25, 26 within the arch shaped slots 23, 24, preferentially, rolling bearings 25′, 26′ are provided respectively on the first 25 and on the second 26 guide pin.

The clamping device 10 comprises sealing means to prevent the infiltration of dirt through the fore opening 13 in the box-shaped body 11.

The opening 13 in the box-shaped body 11 is provided in particular with a first and a second cross edge 13′, 13″, preferentially defined on a removable plate 27 secured to the box-shaped body 11 in correspondence with the opening 13.

Preferentially, the sealing means comprise a closing member 28 for closing the opening 13, which is tiltably supported by the box-shaped body 11 by means of a pivotal pin 29, and has a scraping head 28′ which extends from the back longitudinal surface 12B of the clamping member 12 towards and beyond the second cross edge 13″ of the opening 13.

Elastic thrust means are also provided for urging the closing member 28, for example a helical spring 30, in order to maintain the scraping head 28′ constantly in contact with the back longitudinal surface 12B of the clamping member 12.

Moreover, the front surface 12A of the clamping member 12 is provided with a shaped profile conformed to constantly slide in contact with the first cross edge 13′ of the opening 13 in the box-shaped body 11, in such a way as to form a seal to prevent the infiltration of dirt into the box-shaped body 11.

The device 10 may also comprise detecting means for detecting the position of the clamping member 12, for example a first and a second optical sensor 31, 32 supported by the box-shaped body 11, which are capable of detecting a lug or protrusion 33 connected to the movable rod 14′ of the linear actuator 14.

The clamping device according to this invention therefore makes it possible to achieve the aforementioned objects, and namely allows to exert high clamping forces on the work pieces, maintaining an irreversible clamping condition for the work pieces, and also guaranteeing a precise movement of the clamping member, with limited friction and wear.

What has been described and shown with reference to the accompanying drawings has been given purely by way of example in order to illustrate the general features of the clamping device according to this invention, and one of its preferential embodiments; therefore other modifications and variations to the clamping device are possible, without thereby deviating from the scope of the claims.

What we claim is:

1. Underbody clamping device for work pieces, of the type comprising:
a box-shaped body having a longitudinal axis;
a clamping member, movable between a forward releasing position and a backward retaining position for a work piece, said clamping member comprising a hook-shaped portion at a fore end which extends outwardly through a fore opening of the box-shaped body, and a rear shank;
drive means operatively connected to the clamping member and to a linear actuator, the drive means comprising a drive member, tiltably supported by a pivotal axis connected to the box-shaped body, said tiltable drive member being operatively connected to the shank of the clamping member by a hinge axis, and
guide means for the clamping member, comprising first and second arch shaped slots in said rear shank, and first and second guide pins secured to the box-shaped body, respectively extending into the first and second arch shaped slots, said first and second arch shaped slots being conformed and arranged to cause the clamping member to parallely move with respect to the longitudinal axis of the box-shaped body, along an arched path corresponding to a rotational path of the hinge axis between the tiltable drive member and the rear shank of the clamping member of the device.

2. Clamping device according to claim 1, wherein said first and second arch shaped slots are parallely arranged to each other in said rear shank of the clamping member.

3. Clamping device according to claim 1, wherein said first and second arch shaped slots have respective curvature centres disposed on an opposite side of the clamping member with respect to the pivotal axis of the tiltable drive member.

4. Clamping device according to claim 1, wherein the hinge axis of the drive member is connected to the clamping member in an intermediate position between said first and said second arch shaped slot.

5. Clamping device according to claim 1, comprising respective rolling bearings on said first and second guide pin, sliding within said first and second arch shaped slot.

6. Clamping device according to claim 1, wherein said tiltable drive member is in the form of an incurved tiltable lever, pivotally connected to the box-shaped body in an intermediate point of the same lever, said tiltable lever comprising a first lever arm which extends in a first direction, operatively connected to the clamping member, and a second lever arm which extends in a second direction on an opposite side with respect to said pivotal axis, said second lever arm being operatively connected to the linear actuator.

7. Clamping device according to claim 6, comprising a toggle-lever mechanism operatively connected between the linear actuator and the tiltable drive lever, said toggle-lever mechanism being defined by the second lever arm of the drive member and by an intermediate connecting link between the second lever arm and the linear actuator.

8. Clamping device according to claim 7, wherein the connecting link of said toggle-lever mechanism is elastically yieldable in an axial direction in a controlled manner.

9. Clamping device according to claim 1, comprising sealing means to prevent the infiltration of dirt through said fore opening in the box-shaped body.

10. Clamping device according to claim 9, in which the clamping member has front and back surfaces which extend in the longitudinal direction of the box-shaped body, and in which the opening in the box-shaped body has a first and a second cross edge, wherein said sealing means comprise a closing member for closing said opening, tiltably supported by the box-shaped body, said closing member being provided with a scraping head which extends from the back longitudinal surface of the clamping member towards and beyond one of the cross edges of the opening in the box-shaped body,
elastic thrust means being provided for urging the closing member to maintain the scraping head constantly in contact with the back longitudinal surface of the clamping member, and
wherein the clamping member has a front surface provided with a shaped profile conformed to slide in contact with the other of said cross edges of the opening in the box-shaped body.
